(19) United States
(12) Patent Application Publication
(10) Pub. No.: US 2017/0208079 A1
(43) Pub. Date: Jul. 20, 2017

(54) METHODS FOR DETECTING SECURITY INCIDENTS IN HOME NETWORKS

(71) Applicant: QUALCOMM Incorporated, San Diego, CA (US)

(72) Inventors: Rosario Cammarota, San Diego, CA (US); Peerapol Tinnakornsrisuphap, San Diego, CA (US)

(21) Appl. No.: 15/183,401

(22) Filed: Jun. 15, 2016

Related U.S. Application Data
(60) Provisional application No. 62/280,314, filed on Jan. 19, 2016.

(51) Int. Cl. H04L 29/06; H04W 12/08

(52) U.S. Cl. CPC H04L 63/1425; H04W 12/08; H04L 63/10; H04W 84/12

(57) ABSTRACT

Methods and system for detecting anomalous behavior in a home network is performed by an access point. The access point passively monitors, within the home network, network traffic corresponding to each of a number of devices associated with it, without an approval from any of the number of devices. In another aspect, the access point passively monitors, within the home network, individual traffic flows between the access point and the number of devices associated with it. The access point then compares, for each of the devices, one or more characteristics of the corresponding network traffic or the individual traffic flows with a baseline model of network behavior and identifies which of the number of devices is associated with anomalous behavior based on the comparison.

This application claims priority under 35 USC 119(e) to co-pending and commonly owned U.S. Provisional Patent Application No. 62/280,314 entitled “METHODS FOR DETECTING SECURITY INCIDENTS IN HOME NETWORKS” filed on Jan. 19, 2016, the entirety of which is incorporated by reference herein.

### TECHNICAL FIELD

The example embodiments relate generally to wireless networks, and specifically to detecting anomalous behavior in a wireless home network.

### BACKGROUND OF RELATED ART

A wireless local area network (WLAN) may be formed by one or more access points (APs) that provide a shared wireless medium for use by a number of client devices. Each AP, which may correspond to a Basic Service Set (BSS), periodically broadcasts beacon frames to enable any client devices within wireless range of the AP to establish and/or maintain a communication link with the WLAN. WLANs that operate in accordance with the IEEE 802.11 family of standards are commonly referred to as Wi-Fi networks.

The Internet of Things (IoT), which may refer to a communication system in which a wide variety of objects and devices wirelessly communicate with each other, is becoming increasingly popular in fields as diverse as environmental monitoring, building and home automation, energy management, medical and healthcare systems, and entertainment systems. IoT devices, which may include objects such as sensors, home appliances, consumer electronics, and smart meters, typically communicate with other wireless devices using communication protocols such as Bluetooth or Wi-Fi. The number of IoT devices is expected to grow exponentially in the near future and, with this growth, the number of security incidents related to IoT devices is also expected to increase. IoT devices typically have limited resources, and may not be able to implement security features sufficient to safeguard against security threats.

When deployed within a home network, IoT devices may increase security risks of the home network. Thus, there is a need to mitigate the security risks to home networks (or other networks with limited professional oversight or management) resulting from IoT devices.

### BRIEF DESCRIPTION OF THE DRAWINGS

The example embodiments are illustrated by way of example and are not intended to be limited by the figures of the accompanying drawings.

FIG. 1 shows a block diagram of a wireless system within which the example embodiments may be implemented.

FIG. 2 shows a block diagram of a wireless station (STA) in accordance with example embodiments.

FIG. 3 shows a block diagram of an IoT device in accordance with example embodiments.

FIG. 4 shows a block diagram of an access point (AP) in accordance with example embodiments.

FIG. 5 shows an example operation for monitoring characteristics of network traffic to detect a presence of anomalous behavior.

FIG. 6 shows an illustrative flow chart depicting an example operation for detecting anomalous behavior in network traffic in accordance with the example embodiments.

FIG. 7 shows an illustrative flow chart depicting another example operation for detecting anomalous behavior in network traffic in accordance with the example embodiments.

Like reference numerals refer to corresponding parts throughout the drawing figures.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, Independent Basic Service Set (IBSS) systems, peer-to-peer systems (e.g., operating according to the Wi-Fi Direct protocols), and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), media access control (MAC) protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “anomalous behavior” as used herein may refer to network traffic that is out of the ordinary, suspicious, abnormal, and/or sufficiently different than expected to warrant inspection for malicious activity. The terms “network traffic characteristics” and “characteristics” as used herein may refer to attributes, features, content, and/or any other measurable qualities of data transmissions within, received by, and/or transmitted from a given network.

Further, as used herein, the term “associated AP” refers to an AP with which a given STA is associated (e.g., there is an established communication channel or link between the AP and the given STA). The term “non-associated AP” refers to an AP with which a given STA is not associated (e.g., there is not an established communication channel or link between the AP and the given STA, and thus the AP and the given STA may not yet exchange data frames).

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

As mentioned above, IoT devices are typically small devices with limited resources, and may not be capable of implementing security features typically associated with Wi-Fi devices such as smart phones and tablet computers. When deployed in a network with limited professional oversight or security management (e.g., within a home network), the limited security features of IoT devices may increase the vulnerability of the network to malicious activity such as malware and attacks. Some example attacks may include Denial of Service attacks (DoS), User to Root attack (U2R), Remote to Local attack (R2L), probing attacks, or the presence of an email spam-bot.

In addition, many IoT devices are manufactured by new or unproven vendors that may not adhere to current security standards or policies, and are sometimes deemed to be inherently untrusted devices. For example, some IoT devices may not be certified by the Wi-Fi® alliance. Further, because IoT devices include a diverse array of device types that lack a common standard and/or that may not provide feedback to other devices, networks that include IoT devices may be more complex and more difficult to manage than homogeneous networks (e.g., networks that include only devices compatible with the IEEE 802.11 family of standards). These are at least some of the technical problems to be solved by the example embodiments.

Thus, apparatuses and methods are disclosed that may detect security threats within a home network (or other small network with limited professional oversight or management) without relying upon external resources. More specifically, in accordance with the example embodiments, an access point (AP) in a home network may monitor traffic within or associated with the home network for anomalous behavior without an approval from any of the number of devices associated with the AP, and may identify one or more client devices associated with the anomalous behavior. In addition, the AP may take a number of corrective actions in response to detecting the anomalous behavior and/or in response to identifying the client devices associated with the anomalous behavior. The corrective actions may include, for example, restricting network access of the identified client devices, alerting a user or administrator of the network as to the anomalous behavior and/or to the identity of the client devices associated with the anomalous behavior, and/or providing feedback to one or more remote devices or services. These and other details of the example embodiments, which provide one or more technical solutions to the aforementioned technical problems, are described in more detail below.

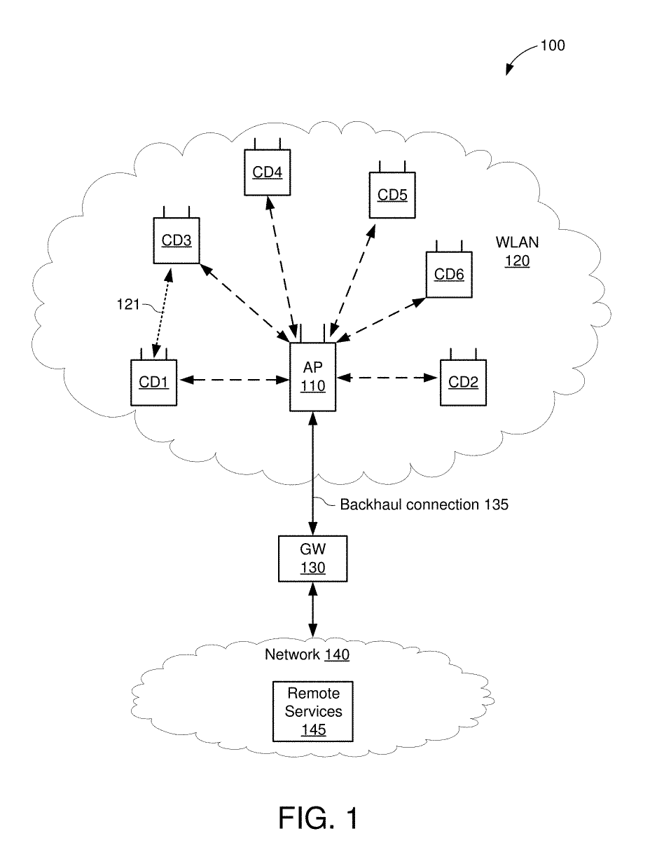

FIG. 1 is a block diagram of a wireless system 100 within which the example embodiments may be implemented. The wireless system 100 is shown to include six client devices CD1-CD6, a wireless access point (AP) 110, a wireless local area network (WLAN) 120, a gateway 130, an external network 140, and a number of remote services 145. Although six client devices CD1-CD6 are depicted in FIG. 1, it is to be understood that the WLAN 120 may be associated with or include any suitable number of client devices. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. For example, for implementations in which WLAN 120 is a home network, the WLAN 120 may include AP 110 and a number of wireless repeaters (not shown for simplicity) that extend the wireless range of AP 110 (e.g., and therefore increase the wireless coverage area of WLAN 120).

The AP 110 may be connected to an external gateway 130 via a backhaul connection 135. The external gateway 130 may be used to connect the WLAN 120 with one or more external networks 140 (only one external network shown for simplicity). The external network 140 may be any suitable network including, for example, a local area network (LAN), a wide area network (WAN), a metropolitan area network (MAN), and/or the Internet. The external network 140 may include or otherwise be associated with a number of remote services 145. Each of the remote services 145 may be any suitable communication device, server, database, and/or object. Communications between WLAN 120 and external network 140 (e.g., between client devices CD1-CD6 and remote services 145) may be managed by gateway 130. In some aspects, gateway 130 may correspond to an edge node or router associated with an Internet Service Provider (ISP) core network.

The AP 110 and each of client devices CD1-CD6 may be assigned one or more unique identifiers or addresses. For example, the AP 110 and each of the client devices CD1-CD6 may be assigned a unique media access control (MAC) address and/or a unique internet protocol (IP) address. The MAC addresses may be used to route data frames between client devices CD1-CD6 within WLAN 120 (e.g., using layer-2 routing techniques), and the IP addresses may be used to route data frames between client devices CD1-CD6 of WLAN 120 and remote services 145 of the external network 140 (e.g., using layer-3 routing techniques).

Each of client devices CD1-CD6 may be any suitable wireless device. More specifically, a first number of the client devices CD1-CD6 may each be a wireless station (STA), and a second number of the client devices CD1-CD6 may each be an IoT device. Each STA may be any suitable Wi-Fi enabled wireless device including, for example, a cell phone, personal digital assistant (PDA), tablet device, laptop computer, or the like. Each STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. Each IoT device may be any suitable device capable of operating according to one or more communication protocols associated with IoT systems including, for example, a smart appliance, a sensor, a gaming console, a smart meter, and the like.

As mentioned above, a STA typically includes more resources than an IoT device. Another distinction between STAs and IoT devices may be that IoT devices typically communicate with other wireless devices using relatively narrow channel widths (e.g., to reduce power consumption), while STAs typically communicate with other wireless devices using relatively wide channel widths (e.g., to maximize data throughput). For example, many IoT devices communicate using narrowband communication protocols such as Bluetooth Low Energy (BLE).

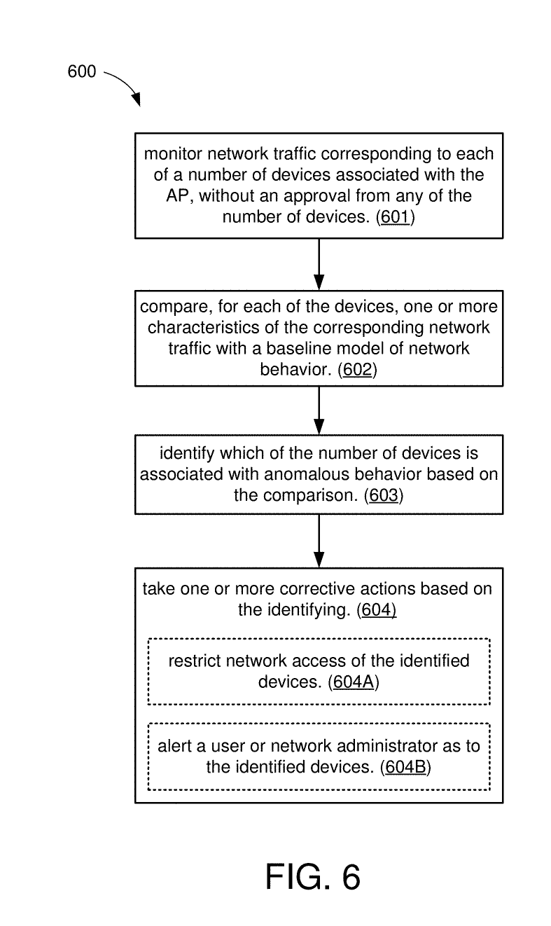

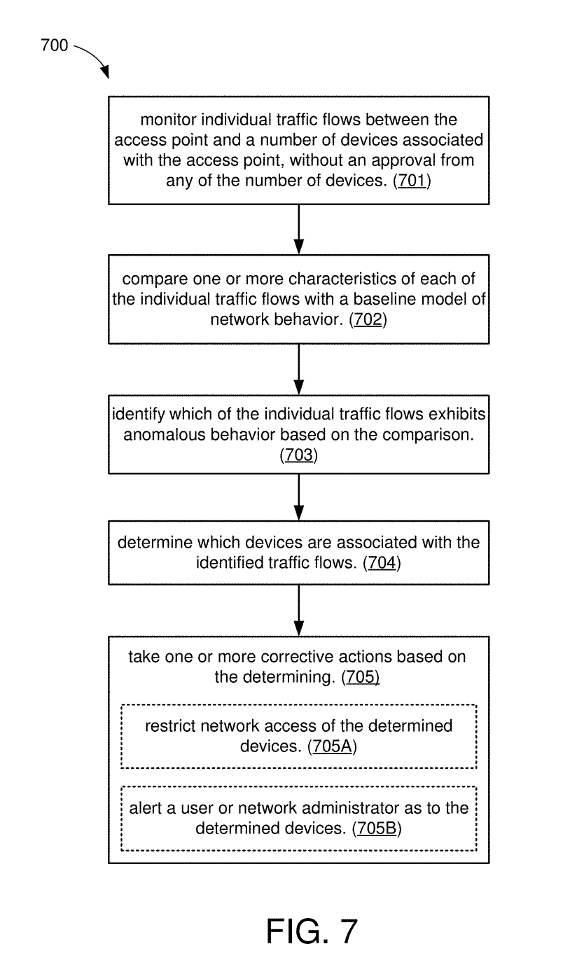

For at least some embodiments, each of client devices CD1-CD6 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The AP 110 may be any suitable device that allows one or more wireless devices (e.g., client devices CD1-CD6) to connect to an external network (e.g., network 140) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

For some implementations, all traffic between WLAN 120 and gateway 130 flows through AP 110, and therefore AP 110 may be configured to monitor all incoming and outgoing data transmissions of WLAN 120. In addition, the AP 110 may be configured to monitor all internal traffic of WLAN 120. The internal traffic of WLAN 120 may include data transmissions between client devices CD1-CD6 routed through AP 110 (e.g., in an infrastructure mode) and/or may include direct data transmissions between client devices CD1-CD6 without involvement of AP 110 (e.g., in a peer-to-peer mode). For example, if client devices CD1 and CD3 exchange data over a peer-to-peer connection or link 121 without involvement of AP 110 (e.g., as depicted in FIG. 1), the AP 110 may be configured to monitor network traffic between client devices CD1 and CD3 even though the traffic is not routed through or controlled by the AP 110.

More specifically, because data exchanged between client devices CD1 and CD3 via peer-to-peer connection or link 121 may be transmitted on a shared wireless medium associated with the WLAN 120 (or at least using a frequency band within an operating bandwidth of AP 110), the AP 110 may receive and inspect frames exchanged between client devices CD1 and CD3. In some aspects, the AP 110 may be configured to inspect all frames transmitted on the shared wireless medium, for example, by ignoring the receiver address (RA) and/or destination address (DA) of the frames. In other aspects, the AP 110 may be configured to inspect all frames having an RA or DA that matches an address or identifier of one or more of client devices CD1-CD6, and/or may be configured to inspect all frames having a transmitter address (TA) or source address (SA) that matches an address or identifier of one or more of client devices CD1-CD6.

For the client devices CD1-CD6 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band, within a 5 GHz frequency band in accordance with the IEEE 802.11 specification, within a 60 GHz frequency band, and/or within frequency bands less than 1 GHz (e.g., in accordance with the Wi-Fi HaLow standards). The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within each of the stations STA1-STA4 may be any technically feasible transceiver such as a ZigBee transceiver described by a specification from the ZigBee specification, a WiGig transceiver, and/or a HomePlug transceiver described a specification from the HomePlug Alliance.

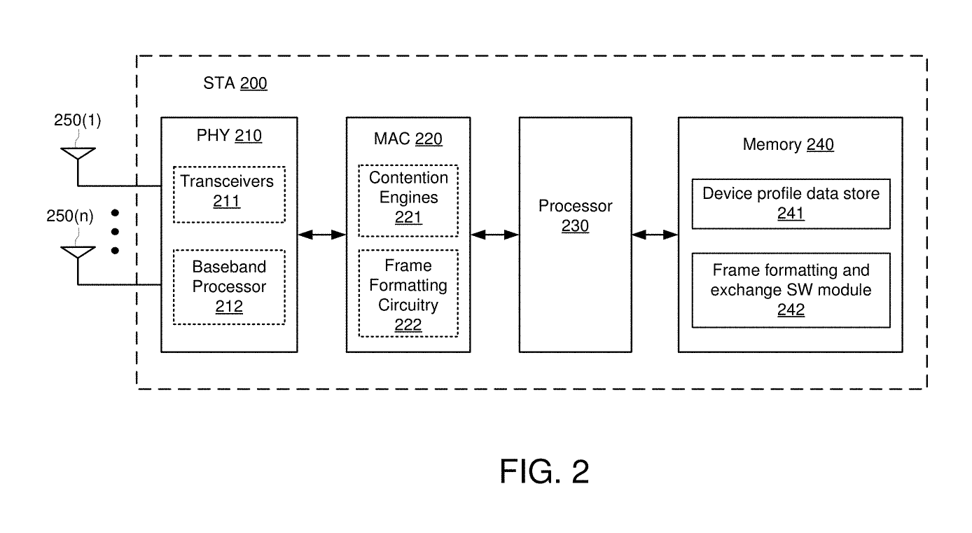

FIG. 2 shows an example STA 200 that may be one or more of client devices CD1-CD6 of FIG. 1. The STA 200 may include a PHY device 210 including at least a number of transceivers 211 and a baseband processor 212, may include a MAC 220 including at least a number of contention engines 221 and frame formatting circuitry 222, may include a processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals other wireless devices, and may be used to scan the surrounding environment to detect and identify nearby access points and/or other wireless devices (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for multiple-input multiple-output (MIMO) operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

The contention engines 221 may contend for access to one more shared wireless mediums, and may also store packets for transmission over the one more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include a device profile data store 241 that stores profile information for a plurality of wireless devices such as APs, IoT device, and/or other stations. The profile information for a particular AP may include information including, for example, the AP's service set identification (SSID), MAC address, channel information, received signal strength indicator (RSSI) values, goodput values, channel state information (CSI), supported data rates, connection history with the AP, a trustworthiness value of the AP (e.g., indicating a level of confidence about the AP's location, etc.), and any other suitable information pertaining to or describing the operation of the AP. The profile information for a particular IoT device or station may include information including, for example, device's MAC address, IP address, supported data rates, and any other suitable information pertaining to or describing the operation of the device.

Memory 240 may also include a non-transitory computer-readable medium (e.g., one or more nonvolatile memory elements, such as EPROM, EEPROM, Flash memory, a hard drive, and so on) that may store at least the following software (SW) module:
a frame formatting and exchange software module 242 to facilitate the creation and exchange of any suitable frames (e.g., data frames, action frames, control frames, and management frames) between STA 200 and other wireless devices (e.g., as described for one or more operations of FIGS. 6 and 7).
   Each software module includes instructions that, when executed by processor 230, cause STA 200 to perform the corresponding functions. The non-transitory computer-readable medium of memory 240 thus includes instructions for performing all or a portion of the STA-side operations described below with respect to FIGS. 6 and 7.

Processor 230, which is shown in the example of FIG. 2 as coupled to PHY device 210, to MAC 220, and to memory 240, may be any suitable one or more processors capable of executing scripts or instructions of one or more software programs stored in STA 200 (e.g., within memory 240). For example, processor 230 may execute the frame formatting and exchange software module 242 to facilitate the creation and exchange of any suitable frames (e.g., data frames, action frames, control frames, and management frames) between STA 200 and other wireless devices.

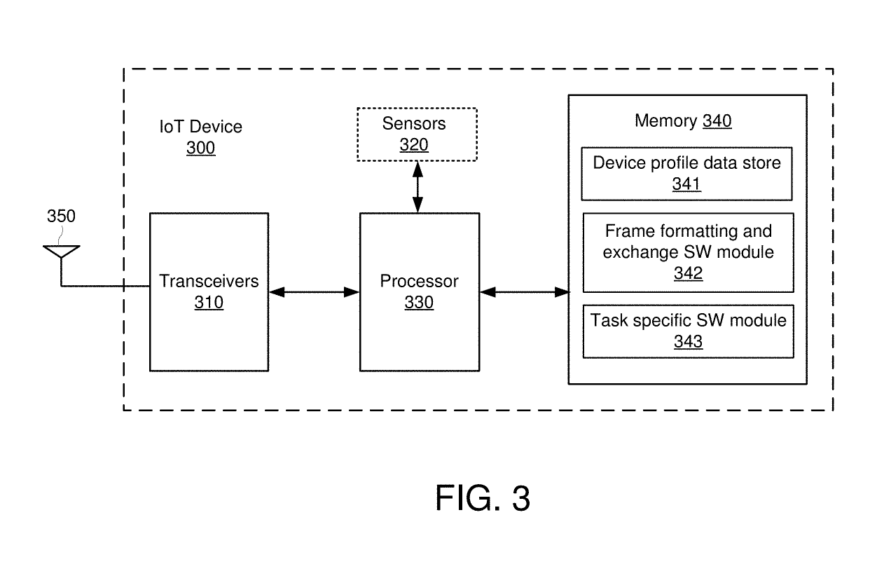

FIG. 3 shows an example IoT device 300 that may be one or more of client devices CD1-CD6 of FIG. 1. The IoT device 300 may include a number of transceivers 310, one or more optional sensors 320, a processor 330, a memory 340, and an antenna 350. The transceivers 310, which are coupled to antenna 350 and processor 330, may be used to transmit signals to and receive signals from other wireless devices, and may be used to scan the surrounding environment to detect and identify nearby access points and/or other wireless devices (e.g., within wireless range of IoT device 300). Although not shown in FIG. 3 for simplicity, the transceivers 310 may include any number of transmit chains to process and transmit signals to other wireless devices, and may include any number of receive chains to process signals received from antenna 350. Further, although the example IoT device 300 is depicted as including only one antenna, for other embodiments, IoT device 300 may include any suitable number of antennas.

Memory 340 may include a device profile data store 341 that stores profile information for a plurality of wireless devices such as APs, IoT device, and/or other stations. The profile information for a particular AP may include information including, for example, the AP's SSID, MAC address, channel information, RSSI values, goodput values, CSI, supported data rates, connection history with the AP, a trustworthiness value of the AP (e.g., indicating a level of confidence about the AP's location, etc.), and any other suitable information pertaining to or describing the operation of the AP. The profile information for a particular IoT device or station may include information including, for example, device's MAC address, IP address, supported data rates, and any other suitable information pertaining to or describing the operation of the device.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames between IoT device 300 and other wireless devices (e.g., as described for one or more operations of FIGS. 6 and 7); and
a task specific software module 343 to facilitate the performance of one or more tasks that may be specific to IoT device 300.
   Each software module includes instructions that, when executed by processor 330, cause IoT device 300 to perform the corresponding functions. The non-transitory computer-readable medium of memory 340 thus includes instructions for performing all or a portion of the operations described below with respect to FIGS. 6 and 7.

Processor 330, which is shown in the example of FIG. 3 as coupled to transceivers 310, sensors 320, and memory 340, may be any suitable one or more processors capable of executing scripts or instructions of one or more software programs stored in IoT device 300 (e.g., within memory 340). For example, processor 330 may execute the frame formatting and exchange software module 342 to facilitate the creation and exchange of any suitable frames between IoT device 300 and other wireless devices. Processor 330 may also execute the task specific software module 343 to facilitate the performance of one or more tasks that may be specific to the IoT device 300. For one example in which IoT device 300 is a smart thermostat, execution of the task specific software module 343 may cause the smart thermostat to adjust a temperature setting in response to one or more signals received from a user. For another example in which IoT device 300 is a smart light switch, execution of the task specific software module 343 may cause the smart light switch to turn on/off or adjust a brightness setting of an associated light in response to one or more signals received from a user.

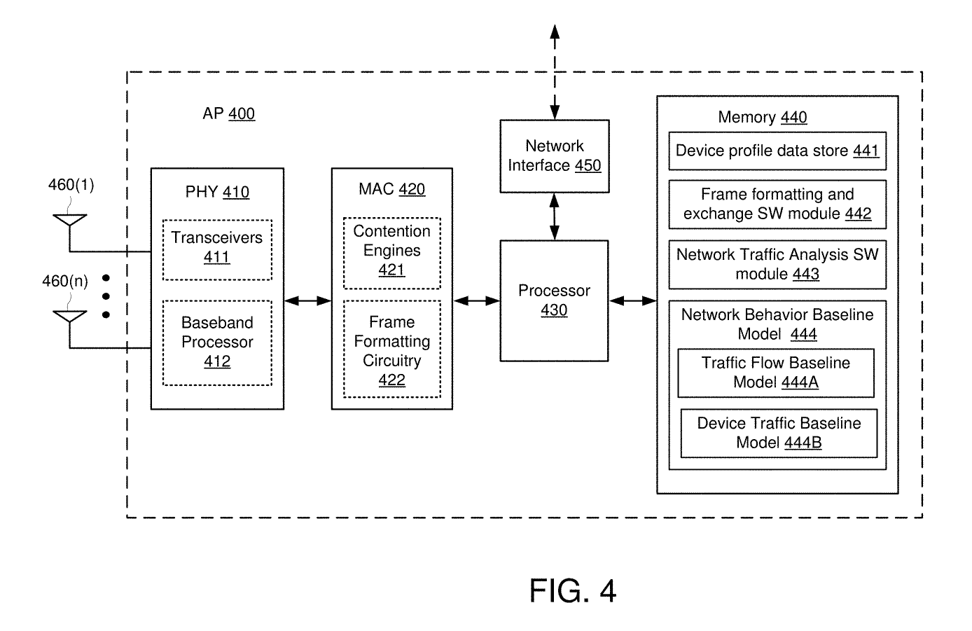

FIG. 4 shows an example AP 400 that may be one embodiment of the AP 110 of FIG. 1. AP 400 may include a PHY device 410 including at least a number of transceivers 411 and a baseband processor 412, may include a MAC 420 including at least a number of contention engines 421 and frame formatting circuitry 422, may include a processor 430, may include a memory 440, may include a network interface 450, and may include a number of antennas 460(1)-460(n). The transceivers 411 may be coupled to antennas 460(1)-460(n), either directly or through an antenna selection circuit (not shown for simplicity). The transceivers 411 may be used to communicate wirelessly with one or more STAs, with one or more other APs, and/or with one or more IoT devices. Although not shown in FIG. 4 for simplicity, the transceivers 411 may include any number of transmit chains to process and transmit signals to other wireless devices via antennas 460(1)-460(n), and may include any number of receive chains to process signals received from antennas 460(1)-460(n). Thus, for example embodiments, the AP 400 may be configured for MIMO operations including, for example, SU-MIMO operations and MU-MIMO operations.

The baseband processor 412 may be used to process signals received from processor 430 and/or memory 440 and to forward the processed signals to transceivers 411 for transmission via one or more of antennas 460(1)-460(n), and may be used to process signals received from one or more of antennas 460(1)-460(n) via transceivers 411 and to forward the processed signals to processor 430 and/or memory 440.

The network interface 450 may be used to communicate with a WLAN server (not shown for simplicity) either directly or via one or more intervening networks and to transmit signals. For some embodiments, the network interface 450 may be used to communicate with an external gateway (e.g., gateway 130 of FIG. 1).

For purposes of discussion herein, MAC 420 is shown in FIG. 4 as being coupled between PHY device 410 and processor 430. For actual embodiments, PHY device 410, MAC 420, processor 430, memory 440, and/or network interface 450 may be connected together using one or more buses (not shown for simplicity).

The contention engines 421 may contend for access to the shared wireless medium, and may also store packets for transmission over the shared wireless medium. For some embodiments, AP 400 may include one or more contention engines 421 for each of a plurality of different access categories. For other embodiments, the contention engines 421 may be separate from MAC 420. For still other embodiments, the contention engines 421 may be implemented as one or more software modules (e.g., stored in memory 440 or within memory provided within MAC 420) containing instructions that, when executed by processor 430, perform the functions of contention engines 421.

The frame formatting circuitry 422 may be used to create and/or format frames received from processor 430 and/or memory 440 (e.g., by adding MAC headers to PDUs provided by processor 430), and may be used to re-format frames received from PHY device 410 (e.g., by stripping MAC headers from frames received from PHY device 410).

Memory 440 may include a device profile data store 441 that stores profile information for a plurality of wireless devices such as stations and/or IoT devices. The profile information for a particular station or IoT device may include information including, for example, device's MAC address, supported data rates, assigned resource block(s) of a wireless channel, and any other suitable information pertaining to or describing the operation of the device.

Memory 440 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 442 to facilitate the creation and exchange of any suitable frames (e.g., data frames, action frames, control frames, and management frames) between AP 400 and other wireless devices (e.g., as described for one or more operations of FIGS. 6 and 7); and
a network traffic analysis software module 443 to facilitate the monitoring of network traffic and individual traffic flows between AP 400 and a number of associated devices (e.g., client devices CD1-CD6 of FIG. 1), the extraction and comparison of one or more characteristics of network traffic and individual traffic flows, and the identification of anomalous network behavior associated with a specific device or a specific individual network flow (e.g., as described for one or more operations of FIGS. 6 and 7).
   Each software module includes instructions that, when executed by processor 430, cause AP 400 to perform the corresponding functions. The non-transitory computer-readable medium of memory 440 thus includes instructions for performing all or a portion of the operations described below with respect to FIGS. 6 and 7.

Processor 430, which is coupled to PHY device 410, to MAC 420, to memory 440, and to network interface 450, may be any suitable one or more processors capable of executing scripts or instructions of one or more software programs stored in AP 400 (e.g., within memory 440). For example, processor 430 may execute the frame formatting and exchange software module 442 to facilitate the creation and exchange of any suitable frames (e.g., data frames, action frames, control frames, and management frames) between AP 400 and other wireless devices. Processor 430 may also execute the network traffic analysis software module 443 to facilitate the monitoring of network traffic and individual traffic flows between AP 400 and a number of associated devices (e.g., client devices CD1-CD6 of FIG. 1), the extraction and comparison of one or more characteristics of network traffic and individual traffic flows, and the identification of anomalous network behavior associated with a specific device or a specific individual network flow.

Memory 440 may also include or store a network behavior baseline model 444 for the associated wireless network. The network behavior baseline model 444 may be an anomaly-free (or near anomaly-free) network traffic model, and may be used to detect anomalous behavior of traffic within or corresponding to the associated wireless network. In some aspects, the network behavior baseline model 444 may be updated as the AP 400 learns to distinguish between anomalous network behavior and non-anomalous network behavior. In other aspects, the network behavior analysis model 444 may be updated by an external server (not shown in FIG. 4 for simplicity) based on learned or received distinctions between anomalous network behavior and non-anomalous network behavior.

For the example embodiment depicted in FIG. 4, the network behavior baseline model 444 may include a traffic flow baseline model 444A and a device traffic baseline model 444B. The traffic flow baseline model 444A may store, for each of a number of individual traffic flows handled by the AP 400, one or more characteristics indicative of normal (e.g., anomaly-free or near anomaly-free) behavior of the corresponding individual traffic flow. The device traffic baseline model 444B may store, for each of a number of devices associated with the AP 400, one or more characteristics indicative of normal (e.g., anomaly-free or near anomaly-free) network behavior of the corresponding device.

As mentioned above, the example embodiments may allow an AP to detect security threats or incidents within an associated home network (or other small network with limited professional oversight or management) without relying upon resources external to the associated home network. More specifically, referring also to FIG. 1, the AP 110 may monitor traffic within or associated with the WLAN 120, without an approval from any of the number of devices (CD1-CD6) associated with AP 110, to detect a presence of anomalous network traffic or behavior. If the AP 110 detects anomalous network traffic or behavior, the AP 110 may identify which of the client devices CD1-CD6 are associated with the anomalous network traffic or behavior and/or may take one or more corrective actions. The one or more corrective action may include, for example, restricting access of the identified client devices to the wireless medium associated with the WLAN 120, alerting a user or administrator of the WLAN 120 as to the anomalous network traffic or behavior, and alerting a user or administrator of the WLAN 120 as to which of the client devices CD1-CD6 are associated with the detected anomalous network traffic or behavior.

In some embodiments, the AP 110 may monitor individual traffic flows originating from and/or destined to WLAN 120, without an approval from any of the number of devices (CD1-CD6) associated with AP 110. In some aspects, an individual traffic flow may correspond to a transmission control protocol (TCP) connection associated with one of the client devices CD1-CD6 (or with the AP 110). For one example, an individual traffic flow may correspond to a TCP connection between one of client devices CD1-CD6 and a device external to WLAN 120 (e.g., one of remote services 145). For another example, an individual traffic flow may correspond to a TCP connection between AP 110 and a device external to WLAN 120 (e.g., one of remote services 145). For yet another example, an individual traffic flow may correspond to a TCP connection (or other type of connection) between a pair of client devices CD1-CD6. For still another example, an individual traffic flow may correspond to a TCP connection (or other type of connection) between one of client devices CD1-CD6 and the AP 110.

More specifically, during a training period, the AP 110 may construct a baseline model for each of a number of traffic flows by monitoring each traffic flow for a time period and then recording one or more monitored characteristics of the traffic flow. Referring also to FIG. 4, the one or more recorded characteristics for each traffic flow may be stored as a corresponding traffic flow baseline model 444A. Thereafter, during a monitoring period, the AP 110 may monitor one or more characteristics of a number of individual traffic flows in real time (e.g., at line speed), and then compare the monitored characteristics with corresponding traffic flow baseline models 444A stored in memory 440. The AP 110 may monitor the individual traffic flows passively, without requiring an approval or permission from any of the devices on the network. The AP 110 may determine whether each of the number of individual traffic flows exhibits or is associated with anomalous behavior based on the comparison and/or may identify each individual traffic flow that exhibits anomalous behavior. The AP 110 may perform the comparison operation on a per-packet basis during a number of relatively short time slots (e.g., ranging from a few seconds to tens of seconds).

In other embodiments, the AP 110 may monitor network traffic corresponding to each of the client devices CD1-CD6 associated with AP 110. For example, during a training period, the AP 110 may construct a baseline model for network traffic corresponding to each of the associated client devices CD1-CD6 by monitoring the network traffic for a time period and then recording one or more monitored characteristics of each device's network traffic. In some aspects, the AP 110 may monitor all network traffic on the shared wireless medium associated with WLAN 120 (e.g., both traffic routed through AP 110 and traffic communicated directly between client devices CD1-CD6 in a peer-to-peer manner). In some aspects, the AP 110 may monitor each device's network traffic passively, without requiring an approval or permission from the particular device. AP 110 may extract status information from each device by monitoring the traffic being sent from and to the particular device. Therefore, if a device seems to act suspicious and goes rogue, the AP 110 can detect such anomalous behavior without the need to poll the rogue device for any status information. Referring also to FIG. 4, the one or more recorded characteristics for each traffic flow may be stored as a corresponding device traffic baseline model 444B. Thereafter, during a monitoring period, the AP 110 may monitor one or more characteristics of each device's network traffic in real time (e.g., at line speed), and then compare the monitored characteristics with corresponding device traffic baseline models 444B stored in memory 440. The AP 110 may determine whether each device's network traffic exhibits or is associated with anomalous behavior based on the comparison and/or may identify which of the client devices CD1-CD6 are associated with anomalous network traffic. The AP 110 may perform the comparison operation on a per-packet basis during a number of relatively long time slots (e.g., as compared with the relatively short time slots described above with respect to monitoring individual traffic flows).

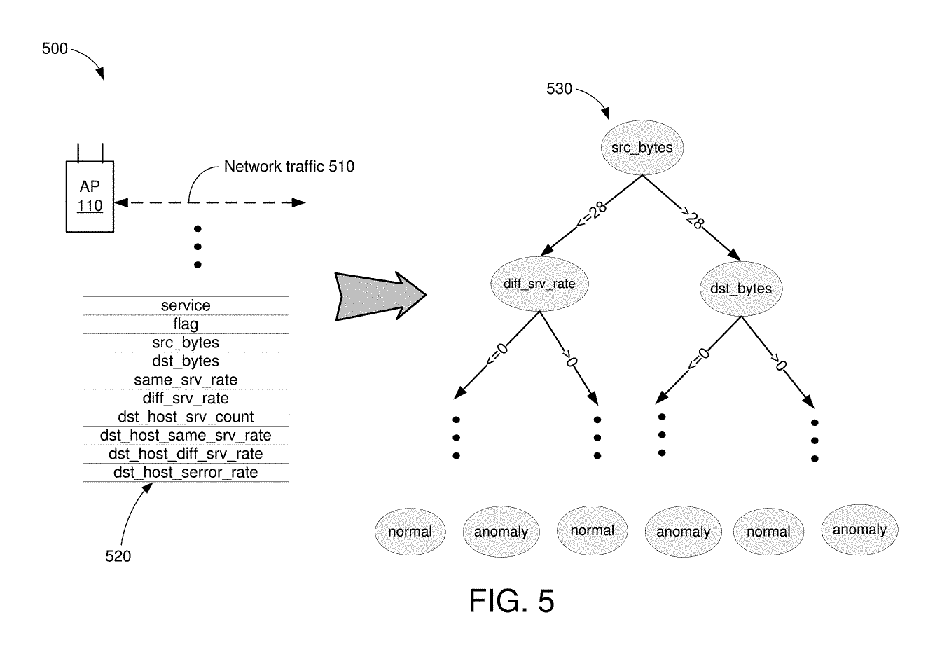

The one or more characteristics monitored by the AP 110 may be any attribute, feature, and/or indication of the traffic flow being monitored. In some aspects, the one or more characteristics to be compared with the network behavior baseline model 444 may be a subset of features included within a known intrusion detection system dataset, for example, as described in more detail below with respect to FIG. 5.

As mentioned above, the traffic flow baseline models 444A and the device traffic baseline models 444B may be constructed by the AP 110. The AP 110 may periodically update the traffic flow baseline models 444A and the device traffic baseline models 444B during one or more subsequent training periods. In addition or as an alternative, the traffic flow baseline models 444A and/or the device traffic baseline models 444B may be constructed by and/or retrieved from a remote server (e.g., external to WLAN 120). The AP 110 may send a number of monitored characteristics of individual traffic flows and/or each device's network traffic to the remote server to aid in the construction and/or updating of the traffic flow baseline models 444A and/or the device traffic baseline models 444B. The remote server may aggregate and group the characteristics received from the AP 110 based on device type, TCP connection, and/or any other suitable parameter. The remote server may build a classification model based on device type, for example, using a classification tree. The device type may be based on information including, for example, device function (e.g., smart meter, smart switch, smart appliance), device transmission capabilities (e.g., Wi-Fi device or IoT device), the device manufacturer, and/or the device model number.

Accordingly, the example embodiments disclosed herein may allow AP 110 to detect security incidents related to IoT devices deployed within WLAN 120 without having prior knowledge of various attack characteristics (e.g., without relying upon a static intrusion detection system dataset) by dynamically monitoring network traffic for the presence of anomalous behavior. In some aspects, the AP 110 may detect such security incidents by executing one or more software programs (e.g., the network traffic analysis SW module 443 of FIG. 4) residing on or otherwise accessible by the AP 110, which may advantageously allow security detection operations performed by the AP 110 to be dynamically updated (e.g., using over-the-air software update techniques). Further, because the AP 110 resides near the network traffic to be monitored (as compared with external routers or edge nodes such as gateway 130), the AP 110 may achieve a high detection accuracy without continuously monitoring the network traffic.

FIG. 5 depicts an example operation 500 for comparing one or more characteristics of network traffic with a corresponding baseline model of network behavior. As depicted in FIG. 5, one or more characteristics of network traffic 510 flowing through AP 110 may be extracted. For some implementations, the extracted characteristics may be a subset of features of a known intrusion detection system dataset. For the example of FIG. 5, table 520 shows a subset of 10 of the 41 features in the well-known NSL-KDD dataset that the AP 110 may monitor and compare with one or more network behavior baseline models. In some aspects, a classification tree 530 may be generated using the 10 features in table 520 and thereafter used to classify the network traffic 510 as normal or anomalous. For other implementations, any suitable technique may be used.

FIG. 6 is an illustrative flow chart depicting an example operation 600 for detecting anomalous behavior in network traffic corresponding to each of a number of client devices associated with a wireless network. The example operation 600 is described below in the context of AP 110 analyzing network traffic within or associated with the WLAN 120 of FIG. 1. First, the AP 110 may monitor network traffic corresponding to each of a number of devices associated with the AP 110, without an approval from any of the number of devices (601). The number of devices may be, for example, the client devices CD1-CD6 of FIG. 1.

The AP 110 may then compare, for each of the devices, one or more characteristics of the corresponding network traffic with a baseline model of network behavior (602). The one or more characteristics to be compared may be a subset of features included within a known intrusion detection system dataset. In some aspects, the one or more characteristics may be compared with a traffic flow baseline model 444A stored in the AP 110.

The AP 110 may then identify which of the number of devices is associated with anomalous behavior based on the comparison (603). In some aspects, the AP 110 may detect a presence of anomalous behavior based on the one or more monitored characteristics not matching one or more corresponding expected characteristics.

Thereafter, the AP 110 may take one or more corrective actions based on the identifying (604). The one or more corrective actions may include restricting network access of the identified devices (604A) and/or alerting a network administrator of the identified devices (604B).

FIG. 7 is an illustrative flow chart depicting an example operation 700 for detecting anomalous behavior in each individual traffic flow at an AP, in accordance with example embodiments. The example operation 700 is described below in the context of AP 110 analyzing network traffic within or associated with the WLAN 120 of FIG. 1. First, the AP 110 may monitor individual traffic flows between the AP 110 and a number of devices associated with the AP 110, without an approval from any of the number of devices (701). The number of devices may be, for example, the client devices CD1-CD6 of FIG. 1.

The AP 110 may then compare one or more characteristics of each of the individual traffic flows with a baseline model of network behavior (702). The one or more characteristics to be compared may be a subset of features included within a known intrusion detection system dataset. In some aspects, the one or more characteristics may be compared with a device traffic baseline model 444B stored in the AP 110.

The AP 110 may then identify which of the individual traffic flows exhibits anomalous behavior based on the comparison (703), and may determine which of the number of devices are associated with the identified individual traffic flows (704). In some aspects, the AP 110 may detect a presence of anomalous behavior based on the one or more monitored characteristics not matching one or more corresponding expected characteristics.

Thereafter, the AP 110 may take one or more corrective actions based on the determining (705). The one or more corrective actions may include restricting network access of the determined devices (705A) and/or alerting a network administrator of the determined devices (705B).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for detecting anomalous behavior in a home network, the method performed by an access point in the home network and comprising:
monitoring, within the home network, network traffic corresponding to each of a number of devices associated with the access point, without an approval from any of the number of devices associated with the access point;
comparing, for each of the devices, one or more characteristics of the corresponding network traffic with a baseline model of network behavior; and
identifying which of the number of devices is associated with anomalous behavior based on the comparison.

2. The method of claim 1, wherein the baseline model of network behavior includes, for each of the number of devices, one or more expected network traffic characteristics.

3. The method of claim 1, further comprising:
taking one or more corrective actions based on the identifying.

4. The method of claim 3, wherein the one or more corrective actions comprises restricting network access to the identified devices.

5. The method of claim 3, wherein the one or more corrective actions comprises alerting a user or network administrator as to the identified devices.

6. The method of claim 1, wherein the one or more characteristics comprise a subset of features in an intrusion detection system dataset.

7. The method of claim 1, wherein the network traffic corresponds to peer-to-peer communications between the number of devices.

8. A method for detecting anomalous behavior in a home network, the method performed by an access point in the home network and comprising:
monitoring, within the home network, individual traffic flows between the access point and a number of devices associated with the access point, without an approval from any of the number of devices associated with the access point;
comparing one or more characteristics of each of the individual traffic flows with a baseline model of network behavior; and
identifying which of the individual traffic flows exhibits anomalous behavior based on the comparison.

9. The method of claim 8, wherein the baseline model of network behavior includes one or more expected characteristics for each of the individual traffic flows.

10. The method of claim 8, further comprising:
determining which of the number of devices are associated with the identified individual traffic flows.

11. The method of claim 10, further comprising:
restricting network access to the determined devices.

12. The method of claim 8, wherein the comparing is performed periodically during one or more time slots.

13. The method of claim 8, wherein each of the individual traffic flows corresponds to a unique TCP connection associated with a selected one of the number of devices.

14. The method of claim 8, wherein a respective one of the individual traffic flows corresponds to at least one member of the group consisting of a number of frames originating from one of the devices associated with the access point and a number of frames destined to one of the devices associated with the access point.

15. The method of claim 8, wherein at least one of the number of devices is an Internet of Things (IoT) device.

16. The method of claim 8, wherein the one or more characteristics comprise a subset of features in an intrusion detection system dataset.

17. An access point for detecting anomalous behavior in a home network, the access point associated with a number of devices and comprising:
one or more processors; and
a memory storing instructions that, when executed by the one or more processors, cause the access point to:
collect, one or more characteristics associated with each of the number of devices;
receive from a server, a classification model indicative of a baseline model of network behavior for a device type, the classification model based on one or more characteristics associated with the device type;
compare traffic characteristics for each of the devices with the baseline model of network behavior; and
identify which of the number of devices is associated with anomalous behavior based on the comparison.

18. The access point of claim 17, wherein the one or more characteristics comprise one or more extracted features in an intrusion detection system dataset.

19. The access point of claim 17, wherein the classification model includes a generic template for a device of the associated device type.

20. A non-transitory computer-readable storage medium storing one or more programs containing instructions that, when executed by one or more processors of an access point, cause the access point to detect anomalous behavior in a home network by performing operations comprising:
collecting, one or more characteristics associated with each of the number of devices;
receiving from a server, a classification model to use as a baseline model of network behavior for a device type, wherein the classification model is built according to one or more characteristics associated with the device type;
comparing traffic characteristics for each of the devices with the baseline model of network behavior; and
identifying which of the number of devices is associated with anomalous behavior based on the comparison.
